(19) United States
(12) Patent Application Publication
(10) Pub. No.: US 2014/0077426 A1
(43) Pub. Date: Mar. 20, 2014

(54) METHOD OF MANUFACTURING POWDER INJECTION-MOLDED BODY

(71) Applicant: MTIG CO., LTD., Seoul (KR)

(72) Inventor: Young Suk Park, Seoul (KR)

(73) Assignee: MTIG CO., LTD., Seoul (KR)

(21) Appl. No.: 14/088,456

(22) Filed: Nov. 25, 2013

Related U.S. Application Data
(63) Continuation of application No. 13/055,032, filed on Jan. 20, 2011, now abandoned.

(30) Foreign Application Priority Data
Jul. 24, 2008 (KR) 10-2008-0071992

(51) Int. Cl. C01G 23/00

(52) U.S. Cl. CPC C01G 23/00
USPC 264/645

(57) ABSTRACT

A method of manufacturing a powder injection-molded body, the method including: mixing at least titanium hydrogen compound (TiHx) powder and a binder to prepare a molding mixture; powder-injecting the molding mixture to form a molded product; degreasing the molded product; and sintering the degreased molded product, wherein in the titanium hydrogen compound, the ratio of hydrogen(H) to titanium(Ti) is greater than 0.45 and less than 1.98.

### CROSS REFERENCE TO RELATED APPLICATIONS

This application is a Continuation Application of co-pending U.S. patent application Ser. No. 13/055,032, filed on Jan. 20, 2011, which is a National Stage

Application of PCT International Application No. PCT/KR2008/006939, filed on November 25, 2008, which claims priority to Korean Patent Application No. 10-2008-0071992, filed on Jul. 24, 2008, which are all hereby incorporated by reference in their entirety.

### BACKGROUND

The present invention directs to a method of manufacturing a powder injection-molded body, and more particularly, to a method of manufacturing a titanium powder injection-molded body, being capable of producing a high-quality final molded product.

Titanium has excellent mechanical characteristics and is harmless to human bodies. Due to these advantages, titanium is used in various industrial devices and mechanical parts. Conventional methods of manufacturing a molded body, such as mechanical parts, using titanium include a sintering method using titanium powder and an injection-molding method using titanium powder and a binder.

However, when a molded body is manufactured, the particle surface of titanium powder reacts with oxygen in the air to form an oxide layer. Due to the oxide layer, it is difficult for pure titanium powder to bind to each other and thus, the resultant titanium molded body has a poor mechanical characteristic. To solve these problems, titanium hydrogen compound powder can be used (see Korean Patent Registration No. 10-072520). However, since there are various titanium hydrogen compound powders, quality of the final molded body is dependent upon the kind of titanium hydrogen compound powder.

### SUMMARY

The present invention provides a method of manufacturing a titanium powder injection-molded body, being capable of producing a high-quality final molded product.

According to an aspect of the present invention, there is provided a method of manufacturing a powder injection-molded body, the method including: mixing at least titanium hydrogen compound (TiHx) powder and a binder to prepare a molding mixture; powder-injecting the molding mixture to form a molded product; degreasing the molded product; and sintering the degreased molded product, wherein in the titanium hydrogen compound, the ratio (x) of hydrogen(H) to titanium(Ti) is greater than 0.45 and less than 1.98.

According to an embodiment of the present invention, the ratio (x) of the hydrogen(H) to titanium(Ti) is greater than 0.5 and less than 1.98. In addition, according to an embodiment of the present invention, the molding mixture may further include metallic substance powder or non-metallic substance powder.

A method of manufacturing a powder injection-molded body according to the present invention utilizes a titanium hydrogen compound. During a degreasing process or a sintering process, a titanium hydrogen compound is decomposed into titanium and hydrogen and the hydrogen reacts with oxygen, carbon, and nitrogen, thereby significantly decreasing production rates of impurities in the sintered product. In addition, the ratio (x) of hydrogen (H) to titanium (Ti) is greater than 0.45 and less than 1.98, and thus, when titanium and hydrogen are released from the titanium hydrogen compound, the content of hydrogen generated is decreased. Accordingly, explosion possibility caused by the generated hydrogen can be significantly decreased. Thus, defective final molded bodies may be less produced and quality of the final molded product may be increased.

If a molding mixture include, in addition to the titanium hydrogen compound, metallic substance powder and/or non-metallic substance powder, characteristics of the final molded body is improved.

### BRIEF DESCRIPTION OF DRAWINGS

FIG. 1 that is a view illustrating a method of manufacturing a powder injection-molded body according to an embodiment of the present invention.

### DETAILED DESCRIPTION

The present invention will now be described more fully with reference to the accompanying drawings, in which exemplary embodiments of the invention are shown.

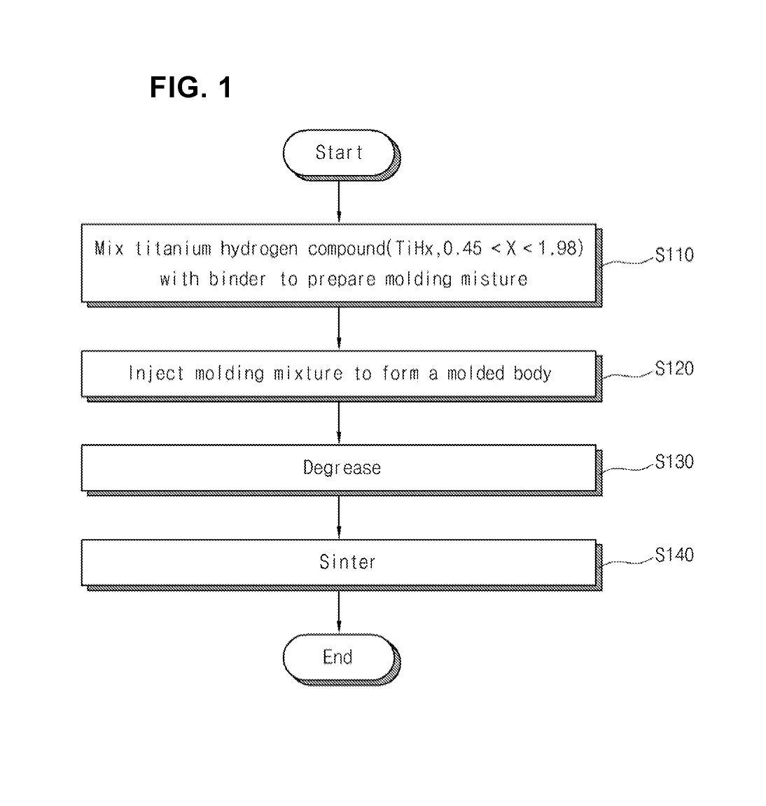

FIG. 1 is a view illustrating a method of manufacturing a powder injection-molded body according to an embodiment of the present invention. Referring to FIG. 1, titanium hydrogen compound (TiHx) powder is prepared. In the titanium hydrogen compound, a ratio (x) of hydrogen (H) to titanium (Ti) is 0.45 to 1.98, specifically 0.5 to 1.98, which will be described in detail later.

The titanium hydrogen compound powder may be prepared using various methods. For example, sponge titanium is heated in the hydrogen gas atmosphere to form TiH₂, and the TiH₂ is dehydrogenated to form TiHx. However, the present invention is not limited to this method.

In general, the particle size of the titanium hydrogen compound powder is 225 mesh or less, specifically 325 mesh or less. Conventionally, to guarantee quality of a final molded body, the particle size of TiH₂ needs to be 625 mesh or less. However, according to the current embodiment, even when the particle size of the titanium hydrogen compound powder is 225 mesh or less, quality of the final molded body can be improved because the sintering can be effectively performed. In addition, some or entire titanium hydrogen compound powder may have the particle size of 225 mesh. Furthermore, to reduce the manufacturing costs of the final molded body and to increase filling properties of powder, at least two type of powder selected from 225 mesh powder, 325 mesh powder, 625 mesh powder, and less than 625 mesh can be mixed and used. Less than 625 mesh powder can also be used.

The titanium hydrogen compound is mixed with a binder to prepare a molding mixture (Operation S110). Examples of the binder include low density polyethylene (LPDP), high density polyethlene (HDPE), polyethylene glycol (PEG), and paraffin wax (PW). In the molding mixture including the titanium hydrogen compound and the binder, the content of the titanium hydrogen compound powder is 40 to 60 vol. % and the content of the binder is the balance.

To improve characteristics of the final molded body, an additive, in addition to the titanium hydrogen compound powder, may be further used. The additive may be a metallic substance or a non-metallic substance. Examples of the metallic substance include iron(Fe), nickel(Ni), cobalt(Co), copper(Cu), stainless, tungsten(W), vanadium(V), aluminum(AI), tin(Sn), manganese (Mn), molybdenum(Mo), chromium(Cr), zirconium(Zr), and silicon(Si). The titanium hydrogen compound has a HCP crystal structure and thus, the titanium hydrogen compound has poor processability and is expensive. However, since Fe and stainless have a BCC structure and Ni and Cu have a FCC structure, when these metals are alloyed with titanium, flexibility is improved and processability is improved. In addition, the alloys are cheaper than titanium. In addition, the alloys require lower sintering temperature than pure titanium and thus, products are inexpensive. In addition, when Co is sintered with the titanium hydrogen compound, the sintering temperature is lowered. In general, the sintering temperature of the titanium hydrogen compound is 1300° C. to 1400° C. However, when Co powder is added, the sintering temperature is lowered to about 1200° C. and thus, a sintered product can be economically manufactured. Furthermore, when Co is added, the strength of the final molded body is improved compared to when Fe or Ni is added. In addition, when Mo, Cr, V, and Mn are added, the high-temperature strength and corrosion resistance of the final molded body are enhanced, and when Zr is added, specifically 6 wt % or less of Zr is added, the high-temperature strength of the final molded body is improved. In a mixed powder including Si powder and the titanium hydrogen compound powder, when the content of Si powder is less than 0.5 wt %, the creep strength of the final molded body is improved.

When Al is added, the density of a product is lowered and the tensile and creep strength of a product are improved. When Sn is added, a solid solution hardening occurs and mechanical characteristics are improved. When W is added, a wear-resistance characteristic of the final molded body is improved.

In a mixed powder including the titanium hydrogen compound powder and the metal substance, the contents of Fe, Ni, and Co may be 10 or less wt % to improve the flexibility of the final molded body. When the content of Cu is 10 wt % to 30 wt %, the strength of the final molded body is improved. However, overall, the content of the metallic substance may be 20 wt % or less to maintain the strength, erosion-resistance property, and lightweight property of titanium itself. The metallic substance may consist of only one metal or a plurality of metals.

Conventional titanium powder is thermodynamically unstable and thus, when titanium bulk is ball-milled, that is, grounded, titanium react with oxygen, nitrogen, and carbon to produce by-products. Accordingly, it is difficult to effectively obtain titanium powder. However, the titanium hydrogen compound is thermodynamically stable and thus, titanium bulk hydrogen compound can be milled to obtain powder. Accordingly, the manufacturing costs are very low.

Herein, the particle size of final powder may be 225 mesh or less, specifically 325 mesh or less. In this case, the metallic substance powder can be used in the ball-milling process to mix with the titanium hydrogen compound powder. Alternatively, the metallic substance power can be used after the titanium hydrogen compound powder is prepared, that is, the metal powder is mixed with the prepared titanium hydrogen compound powder using a mixing device. Those mixed powders are mixed with the binder.

As the additive, W powder and tungsten carbide (WC) powder can also be used. The W powder is mixed with WC powder and the mixture of W and WC powder has an excellent wear-resistance characteristic. The particle size of the mixed powder including W and WC may be 5 micrometers or less, and the particle size of the titanium hydrogen compound powder may be 225 mesh or less, specifically 325 mesh or less. However, when the particle size of the mixed powder including W and WC is 1 micrometer or less, the wear-resistance characteristic of the final molded body is improved. The mixed powder including W and WC, the titanium hydrogen compound powder, and the binder are mixed to prepare a molding mixture. In the mixed powder including the titanium hydrogen compound powder, W, and WC, the ratio of W and WC may be 20 wt % or less. If the content of the mixed powder including W and WC is greater than 20 wt %, the content of the mixed powder including W and WC is relatively high and thus, segregation is formed in the molding mixture and uniformity of the molding mixture may be degraded.

The non-metallic substance may be ceramic powder. Example of the ceramic include ZrO₂, Al₂O₃, TiN, TiC, TiO₂, Si₃N₄, SiC, and SiO₂. The ceramic is a metal ceramic composite substance and when added, the wear-resistance characteristic and high-temperature strength of the final molded body are improved. In a mixed powder including the ceramic powder and the titanium hydrogen compound powder, the content of the ceramic powder may be 20 wt % or less. The particle size of the ceramic may be 5 micrometers or less, and the particle size of the titanium hydrogen compound powder may be 225 mesh or less, specifically 325 mesh or less. However, when the particle size of the ceramic powder is 1 micrometer, the strength of the final molded body is improved. The ceramic powder, the titanium hydrogen compound powder and the binder are mixed to prepare a molding mixture.

Hereinafter, the molding mixture will now be described in detail, assuming that the additive is not be used. The binder may have various mixture ratios. For example, the content of LDPE may be 10 to 20 vol. %, the content of HDPE may be 10 to 20 vol. %, the content of PEG may be 5 to 10 vol. % and the content of PW may be 1 to 10 vol. %.

In the molding mixture, each of the titanium hydrogen compound powder particles is surrounded by the binder. The molding mixture can be present in a form of a lump due to inter-binding of the binder, but may be easily broken into powder (feed stock.)

The molding mixture may retain sufficient flowability in an injection-molding device. In addition, immediately after being injected, the strength of the molding mixture when a sintering process is not yet performed can be maintained by HDPE and LDPE. In addition, in a subsequent degreasing process, PEG is removed by a hexane, thereby forming pores in the molding mixture, and PW can be removed through the pores and LDPE and HDPE are sequentially removed, thereby minimizing the shape change of the molded product. The mixing may be performed using a double planetary mixer or a screw mixer.

When the molding mixture is prepared, the molding mixture is injected to a mold using a powder injection-molding apparatus to obtain a molded body having a selected shape (S120). The powder injection-molding apparatus may be variously selected by one of the ordinary skill in the art. The powder injection may be performed by injecting the molding mixture that has been heated to 350° C., under an injection pressure of 1000 to 5000 [psi].

The molded product is degreased (S130). The degreasing process is performed to remove the binder from the molded product, by thermally decomposing the molded product in a vacuum furnace. For example, in the degreasing process, in a vacuum condition (degree of vacuum is 10⁻³ to 10⁻⁶ atm) including selected inert gas, such as nitrogen (N₂) or argon (Ar), and a hydrogen gas, or in an atmosphere, the molded body is heated from room temperature (20° C.) to 300° C. at a heating rate of 0.5-1° C./min and at 300° C. and the temperature is maintained for 3 to 5 hours, and then the heated molded body is heated from 300° C. to 700° C. at a heating rate of 0.5-1° C./min and at 700° C. and the temperature is maintained for 3 to 5 hours.

If a conventional molded product including titanium powder is degreased, titanium powder may react with carbon, oxygen, nitrogen, and hydrogen to form TiC, TiO₂, TiN, TiH₂ etc. at about 400° C. due to its low thermodynamic stability. TiC, TiO₂, and TiN are not decomposed during the sintering process and remained in the final molded product, thereby decreasing quality of the final molded product. In addition, even in the titanium hydrogen compound, if the ratio of the hydrogen is 0.45 or less, the thermodynamic stability of the titanium hydrogen compound is low, and thus, the titanium hydrogen compound may react with oxygen, carbon, nitrogen, and hydrogen to form TiO₂, TiC, TiN, TiH₂ etc. Specifically, when the ratio of hydrogen is 0.5 or less, thermodynamic stability may be substantially decreased compared to when the ratio of the hydrogen is higher than 0.5. Accordingly, the ratio of hydrogen may be higher than 0.5.

However, if the ratio of the hydrogen is 1.98 or more, when hydrogen is decomposed from the titanium hydrogen compound during the degreasing process, energy is generated between the decomposed products. For the titanium hydrogen compound, when hydrogen is decomposed from the titanium hydrogen compound, a large energy is generated and thus, small explosions occurs in the powder, thereby damaging the molded product, degrading uniformity of the surface, and increasing tolerance in assembling process. As a result, quality of the final molded body is degraded.

Accordingly, the ratio of the hydrogen may be 0.45 to 1.98, specifically 0.5 to 1.98.

The degreasing process will now be described in detail. In an initial temperature range, pathways for removing binders are formed in a injection-molded body, in an intermediate temperature range, a low-temperature binder is removed, and then, in a high temperature range, a high-temperature binder is removed.

Meanwhile, the degreasing process may further include a solvent-extraction type degreasing process. According to the solvent-extraction type degreasing process, an injection-molded product is immersed in a solvent to leach and remove a binder. In this regard, an available solvent may differ according to the type of a binder used. Examples of the solvent include methanol, butanol, hexane, and dichloromethanol. Specifically, when PEG is included as the binder, the injected molded product is immersed in hexane at 50 to 80° C. for 3 hours, thereby extracting and removing PEG from the molded product. As described above, when the solvent-extraction type degreasing process is further included, the solvent-extraction type degreasing process may be performed before the thermal decomposition degreasing process.

Then the degreased molded product is sintered in a sintering furnace (S140).

The sintering process may be performed in a high-vacuum condition (degree of vacuum: 10⁻⁶ to 10⁻³ atm) containing an inert gas such as Ar. The sintering process may be performed in a separate sintering furnace or the same vacuum furnace in which the degreasing process has been completed. During the sintering, the titanium hydrogen compound powder is dehydrogenated to generate pure titanium sintered product. The molded product is sintered when placed at 1300° C. for 1 to 5 hours after the temperature is increased from 700° C. to 1300° C. at a heating rate of 1-5° C./min. However, the present invention is not limited thereto.

The sintering process described above may be performed in a high-vacuum condition. However, the sintering process may also be performed in a low-vacuum condition (degree of vacuum: 10⁻³ to 10⁻¹ atm) containing an inert gas such as Ar. If titanium powder itself is sintered, titanium hydrogen compound may react with carbon, oxygen, and nitrogen at the sintering temperature and forms TiC, TiO₂, TiN etc. TiC, TiO₂, and TiN are not decomposed during the sintering process and remain in the final molded product, thereby degrading quality of the final molded product. However, the titanium hydrogen compound is decomposed into Ti and H₂ at the sintering temperature, and H₂, instead of Ti, reacts with carbon, oxygen, and nitrogen. Accordingly, production rates of those impurities may be significantly reduced and thus, the sintering can be performed in the low-vacuum condition. Since the high-vacuum is embodied using a diffusion pump, a high-vacuum apparatus is very expensive. However, since the low-vacuum is embodied using a rotary pump, the low-vacuum can be realized at low costs. Accordingly, in the present embodiment, quality of the final molded body is maintained at high and the sintering process is inexpensive.

Through the sintering process, the final molded body is completely manufactured. However, the present invention is not limited thereto and may further include a post treatment process.

While the present invention has been particularly shown and described with reference to exemplary embodiments thereof, it will be understood by those of ordinary skill in the art that various changes in form and details may be made therein without departing from the spirit and scope of the present invention as defined by the following claims.

A method of manufacturing a titanium powder injection-molded body according to the present invention, is capable of producing a high-quality final molded product.

What is claimed is:

1. A method of manufacturing a powder injection-molded body, the method comprising:
mixing at least titanium hydrogen compound (TiHx) powder and a binder to prepare a molding mixture;
powder-injecting the molding mixture to form a molded product;
degreasing the molded product; and
sintering the degreased molded product, wherein
in the titanium hydrogen compound, the ratio (x) of hydrogen(H) to titanium(Ti) is greater than 0.45 and less than 1.98.

2. The method of claim 1, wherein the ratio of hydrogen(H) to titanium(Ti) is greater than 0.5 and less than 1.98.

3. The method of claim 1, wherein in the sintering, the degreased molded product is sintered in a low-vacuum condition.

4. The method of claim 1, wherein the titanium hydrogen compound (TiHx) powder has a particle size of greater than 625 mesh.

5. The method of claim 1, wherein the molding mixture further comprises metallic substance powder.

6. The method of claim 5, wherein the metallic substance powder comprises at least one metal selected from the group consisting of aluminum(AI), tin(Sn), manganese (Mn), molybdenum(Mo), zirconium (Zr), iron (Fe), nickel(Ni), cobalt(Co), vanadium (V), silicon(Si), stainless, chromium (Cr) and copper (Cu).

7. The method of claim 6, wherein the metallic substance powder is mixed with the titanium hydrogen compound powder by ball-milling or by using a mixing device, and then the mixed powder is mixed with the binder.

8. The method of claim 5, wherein in the mixed powder comprising the titanium hydrogen compound powder and the metallic substance powder, the ratio of the metallic substance powder is less than 20 wt %.

9. The method of claim 5, wherein the particle size of the mixed powder comprising the titanium hydrogen compound powder and the metallic substance powder have a particle size of which is greater than 625 mesh.

10. The method of claim 1, wherein the molding mixture further comprises tungsten (W) powder and tungsten carbide (WC) powder.

11. The method of claim 10, wherein in the mixed powder comprising the titanium hydrogen compound powder, the tungsten(W) powder and the tungsten carbide(WC) powder, the ratio of the tungsten(W) powder and the tungsten carbide(WC) powder is less than 20 wt %.

12. The method of claim 10, wherein the tungsten(W) powder and the tungsten carbide(WC) powder comprises powder having the particle size of 5 micrometers or less, and the titanium hydrogen compound powder comprises powder having the particle size of 225 mesh or less.

13. The method of claim 1, wherein the molding mixture further comprises non-metallic powder.

14. The method of claim 13, wherein the non-metallic powder comprises ceramic powder.

15. The method of claim 14, wherein the ceramic powder comprises at least one selected from the group consisting of ZrO₂, Al₂O₃, TiN, TiC, TiO₂, Si₃N₄, SiC and SiO₂.

16. The method of claim 13, wherein in the mixed powder comprising the titanium hydrogen compound powder and the ceramic powder, the ratio of the ceramic powder is less than 20 wt %.

17. The method of claim 13, wherein the ceramic powder comprises powder having the particle size of 5 micrometers or less, and the titanium hydrogen compound powder comprises powder having the particle size of which is more than 625 mesh.
